(19) United States
(12) Patent Application Publication
(10) Pub. No.: US 2010/0136433 A1
(43) Pub. Date: Jun. 3, 2010

(54) METHOD OF PREPARING SPHERICAL SHAPE POSITIVE ACTIVE MATERIAL FOR LITHIUM SECONDARY BATTERY

(75) Inventors: Kyung Su Kim, Seoul (KR); Sa Heum Kim, Gyeonggi-do (KR); Dong Gun Kim, Seoul (KR); Young Jun Kim, Gyeonggi-do (KR); Jun Ho Song, Gyeonggi-do (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KOREA ELECTRONICS TECHNOLOGY INSTITUTE

(21) Appl. No.: 12/486,938

(22) Filed: Jun. 18, 2009

(30) Foreign Application Priority Data
Nov. 28, 2008 (KR) 10-2008-0120056

(51) Int. Cl. H01M 4/58; H01B 1/12

(52) U.S. Cl. 429/231.95; 252/519.3

(57) ABSTRACT

The present invention relates to a process of preparing a spherically-shaped positive active material for a lithium secondary battery, comprising: (a) uniformly dissolving a raw material mixture comprising a lithium-based compound, a transition metal, phosphate-based compound and a carbon source in deionized water; (b) preparing a high density spherically-shaped precursor by rapidly freezing the mixed solution in a freeze granulator and sublimating the frozen mixed solution; and (c) thermally treating the high density spherically-shaped precursor.

The thus-prepared spherically-shaped positive active material is superior in crystallinity and electric conductivity, thus being useful in the manufacture of an electrode for a lithium secondary battery.

### CROSS-REFERENCE TO RELATED APPLICATION

This application claims under 35 U.S.C. §119(a) the benefit of Korean Patent Application No. 10-2008-0120056 filed Nov. 28, 2008, the entire contents of which are incorporated herein by reference.

### BACKGROUND

(a) Technical Field

The present invention relates to a process of preparing a spherically-shaped positive active material for a lithium secondary battery, and particularly to a process of preparing the same, which comprises (a) uniformly dissolving a raw material mixture comprising a lithium-based compound, a transition metal, phosphate-based compound and a carbon source in deionized water, (b) preparing a high density spherically-shaped precursor by rapidly freezing the mixed solution in a freeze granulator and sublimating the frozen mixed solution, and (c) thermally treating the high density spherically-shaped precursor.

(b) Background Art

With the rapidly increasing demand for portables such as laptop computers, camcorders, mobile phones and small-sized recorders and the recent trend of reduction in size of these portables, a lithium secondary battery used as an energy source for these portables have been developed so as to increase energy density and extend operable time. The most important part in a lithium secondary battery is the materials for negative and positive electrodes. In particular, it is essential that the material for a lithium secondary battery positive electrode meet the requirements of relatively high discharge capacity, low price, superior cycleability for increasing the operable time and thermal and structural stabilities with no explosion risk.

Transition metal oxides having a layered or spinel structure are widely used as positive active material for a lithium secondary battery. Recently, lithium transition metal phosphate positive active material with a superior stability has been widely studied. In particular, attention has been drawn to LiFePO₄ of olivine structure because of its high theoretical capacity (170 mAh/g) and superior high-temperature stability and a low price due to the use of Fe, despite its relatively low voltage (3.4 V lower than that of lithium).

LiFePO₄ shows a relatively high discharge capacity, and is low priced because comparatively cheap Fe is used instead of Co. LiFePO₄ is also eco-friendly because no heavy metal is contained. Moreover, LiFePO₄ is chemically and structurally stable and shows a relatively long usable time. In particular, LiFePO₄ shows a remarkable thermal stability, thus being appropriate for the positive electrode material of an automotive lithium secondary battery. However, a change in the oxidation from Fe²⁺ to Fe³⁺ during the manufacture of LiFePO₄ should be avoided. Pure LiFePO₄ is significantly low in Li-expansion coefficient (10⁻¹⁴ cm²/s) and electric conductivity (10⁻⁸-10⁻⁹ s/cm), and LiFePO₄ is thus much lower than LiCoO₂ in a rate capability.

In a conventional process of preparing LiFePO₄, processing the mixture of solid-phase Li₂CO₃, NH₄H₂PO₄ and FeC₂O₄ is conducted at 800° C. under an argon atmosphere. LiFePO₄ is relatively low in electric conductivity, thus requiring an additional step of mixing LiFePO₄ with carbon for increasing the conductivity of electrodes.

### SUMMARY OF THE DISCLOSURE

One aspect of the present invention provides a process of preparing a spherically-shaped positive active material for a lithium secondary battery, which comprises (a) uniformly dissolving in deionized water a raw material mixture comprising a lithium-based compound, a transition metal, phosphate-based compound and a carbon source, (b) preparing a high density spherically-shaped precursor by rapidly freezing the mixed solution in a freeze granulator and sublimating the frozen mixed solution, and (c) thermally treating the high density spherically-shaped precursor.

Another aspect of the present invention provides a process of preparing a spherically-shaped positive active material for a lithium secondary battery, which comprises (a) preparing a raw material mixture comprising a lithium-based compound, a transition metal, phosphate-based compound and a carbon source; (b) preparing a mixed solution by uniformly dissolving the raw material mixture in deionized water; (c) rapidly freezing the mixed solution in a freeze granulator; (d) preparing a high density spherically-shaped precursor by sublimating the frozen mixed solution; and (e) thermally treating the high density spherically-shaped precursor.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 shows the energy density of positive active material (LiFePO₄/C composite material) prepared by a process according to the present invention;

FIG. 2 shows the energy density of positive active material prepared by a conventional method;

FIG. 3 schematically shows a freeze granulation procedure;

FIG. 4 shows the particle shape of precursors prepared by a process according to the present invention;

FIG. 5 is SEM (scanning electron micrograph) images showing the particle shape of synthesized lithium phosphate; and

FIG. 6 is XRD data of synthesized lithium phosphate positive active material.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

A raw material mixture comprising a lithium-based compound, a transition metal, a phosphate-based compound and a carbon source is prepared. The raw material comprises 8-12 wt % of the lithium-based compound, 40-50 wt % of the transition metal, 20-25 wt % of the phosphate-based compound and 13-32 wt % of the carbon source.

Non-limiting examples of the lithium-based compound include LiPO₄, Li₂CO₃, LiOH and acetate-lithium (Li-acetate). Non-limiting examples of the transition metal include an iron-containing compound selected from the group consisting of FeSO₄.7H₂O, FeC₂O₄.2H₂O, iron oxalate(Fe-oxalate) and iron acetate (Fe-acetate). Non-limiting examples of the phosphate-based compound include phosphoric acid and ammonium phosphate ((NH₄)₂HPO₄). A preferable example of the carbon source is citric acid with superior electric conductivity.

A preferable molar ratio of a lithium-based compound to a transition metal is in the range of 0.95-1.10:1. If the molar ratio is less than 0.95:1, the production of impurities such as Fe₂O₃ and Fe₂P can increase. If the molar ratio is more than 1.10:1, the production of impurities such as Li₂CO₃ and LiOH can increase.

The raw material mixture is uniformly dissolved in deionized water (DI water) to provide a mixed solution.

The mixed solution is rapidly frozen in a freeze granulator to provide a spherically-shaped precursor.

The present invention adopts a freezing method and differs from the conventional process using a solid-phase method. Unlike the conventional method, the present method can uniformly mix raw materials. The present invention also efficiently overcomes the problem of a relatively low energy density per unit volume due to small secondary particles in a conventional process of preparing an olivine positive electrode material. Energy density per unit volume can be controlled by adjusting the size of a spherically-shaped precursor, thereby improving reversible capacity of a battery.

The frozen spherically-shaped precursor is sublimated to provide high density spherically-shaped precursor. The spherically-shaped precursor is sublimated in a drier at −10-0° C. and 10⁻⁵-10⁻¹ Pa for a period of time between 6 minutes and 6 hours. Water can be removed and high density spherically-shaped precursor can be prepared by this sublimation step, thereby enabling to control the amount of remaining carbon.

Then, the thus-obtained high density spherically-shaped precursor is thermally treated. The thermal treatment is conducted under a reductive atmosphere in a gas mixture containing 3-7% of hydrogen and 93-97% of argon at 500-800° C. for 1-10 hours. Thus prepared spherically-shaped positive active material for lithium secondary battery has a particle size of 5-20 μm. If the particle size is less than 5 μm, the degree of granulation decreases drastically. When the particle size in more than 20 μm, the time necessary for lithium ions to migrate into particles can be extended, thereby deteriorating power output characteristics of the battery.

The final spherically-shaped positive active material for a lithium secondary battery prepared is LiFePO₄/C. The molar ratios of Li/Fe and P/Fe are 0.98-1.06:1 and 0.98-1.02:1, respectively.

Hereunder is provided a detailed description of a process of preparing a spherically-shaped positive electrode for a lithium battery by using the aforementioned spherically-shaped positive active material.

Solid matter (35-42%) is prepared by dissolving in N-methyl pyrrolidone (NMP) a mixture comprising (i) 85-90 wt % of the aforementioned spherically-shaped positive active material for lithium secondary battery, (ii) 1-10 wt % of a conductive material and (iii) 1-10 wt % of a binder. The solid matter is coated on an aluminum-foil, and dried at 110-120° C., followed by the roll-pressing of the dried solid matter at 2 g/cc. Although any known materials can be used as the conductive material and the binder, super-P+ carbon nanotube (vapor growth carbon fiber) and polyvinylidene fluoride (PVDF) are preferred for the conductive material and the binder, respectively.

### EXAMPLES

The following examples illustrate the invention and are not intended to limit the same.

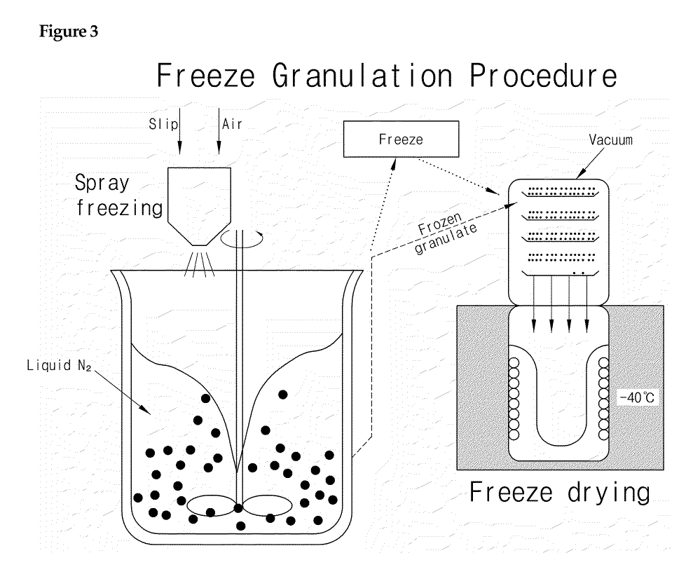

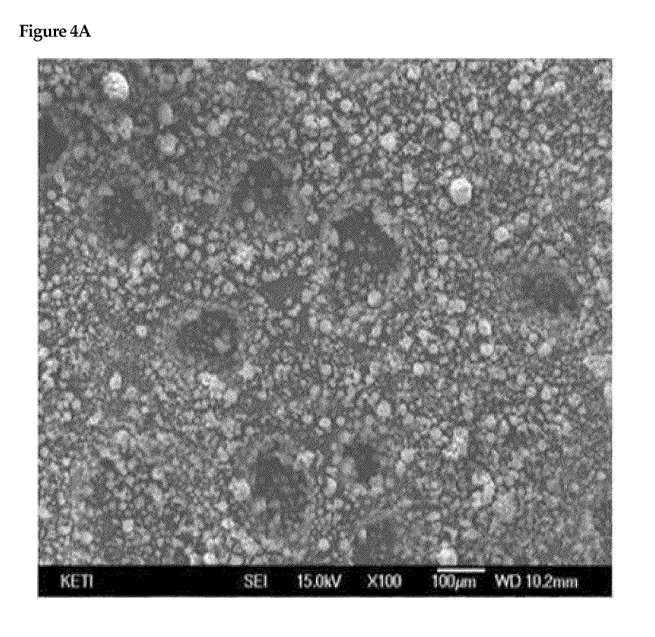

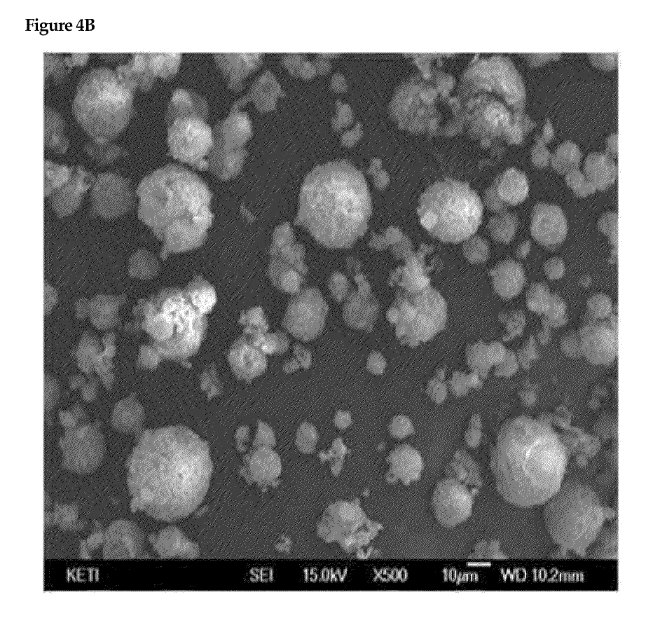

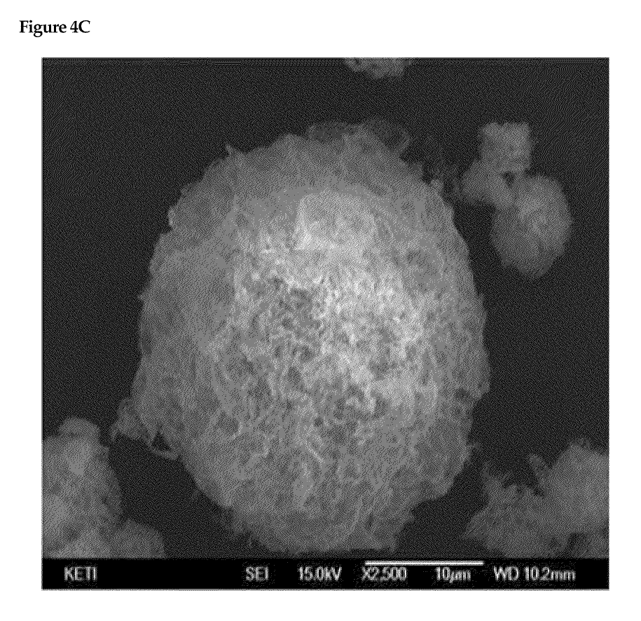

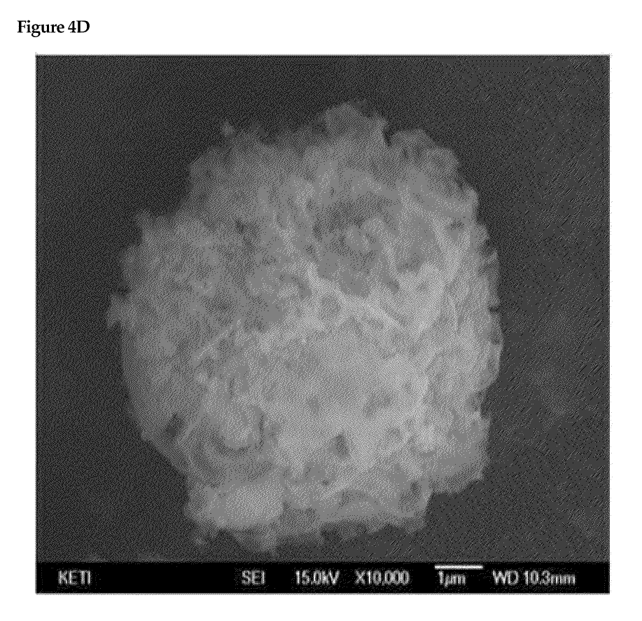

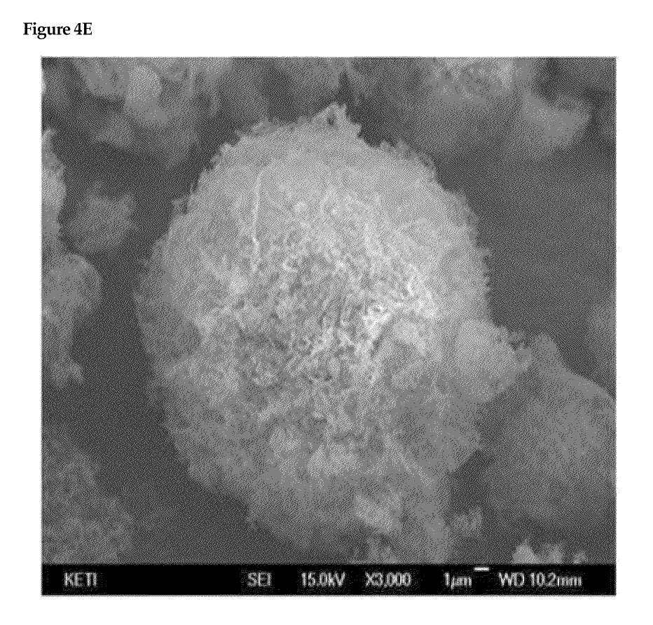

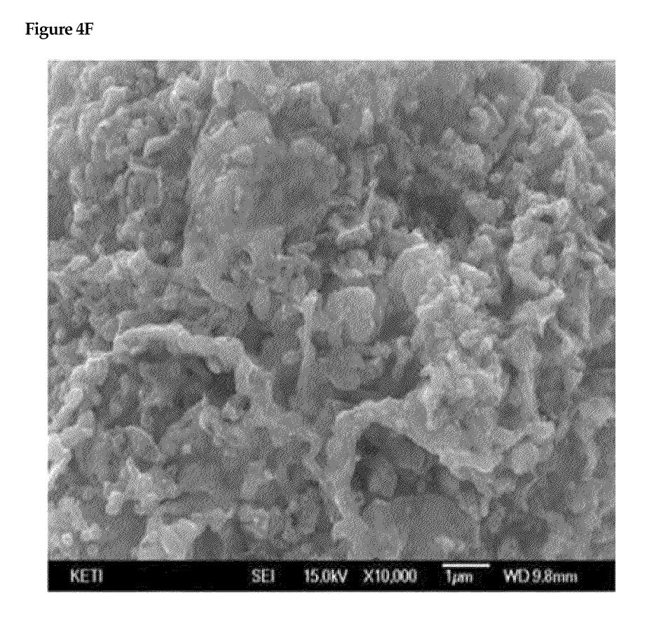

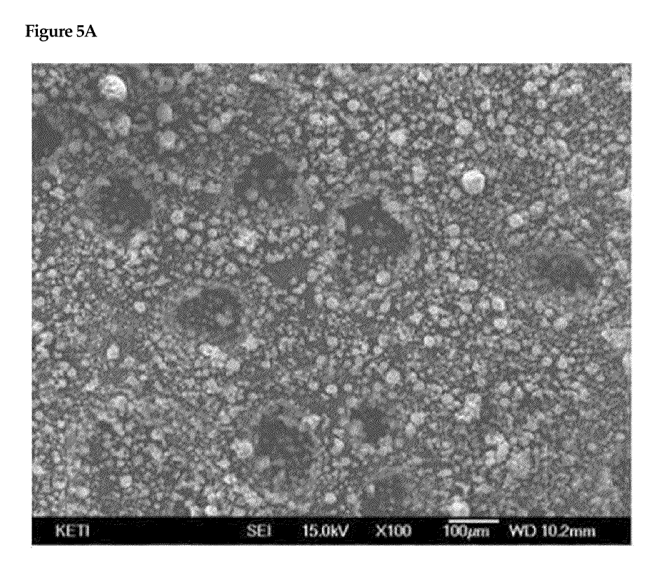

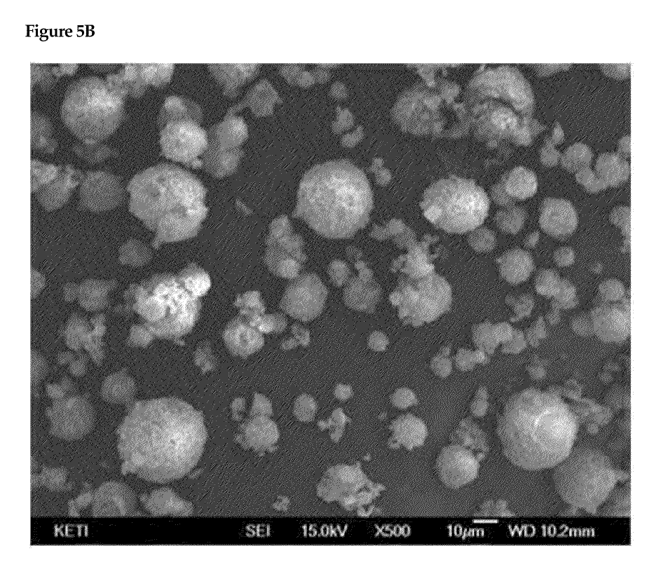

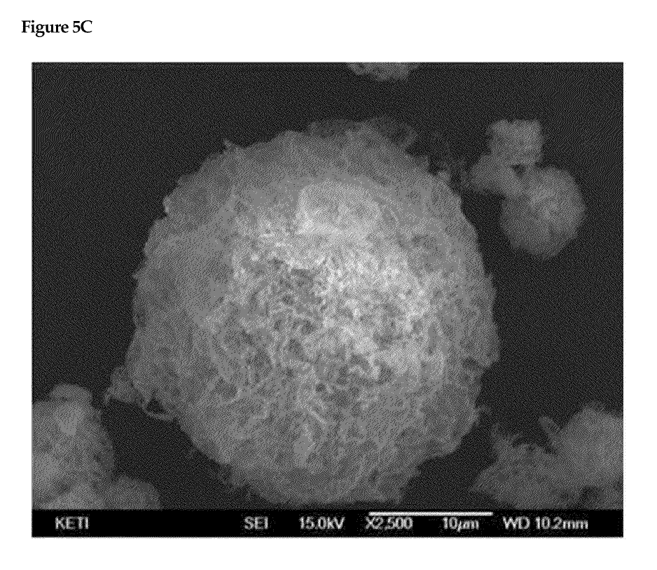

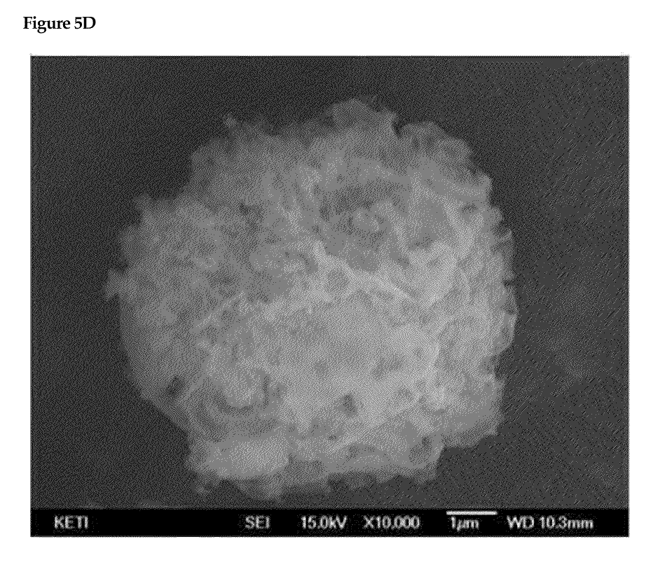

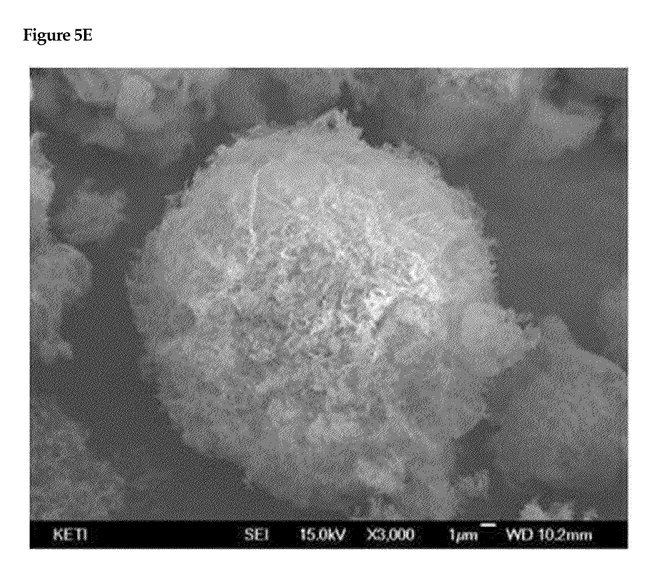

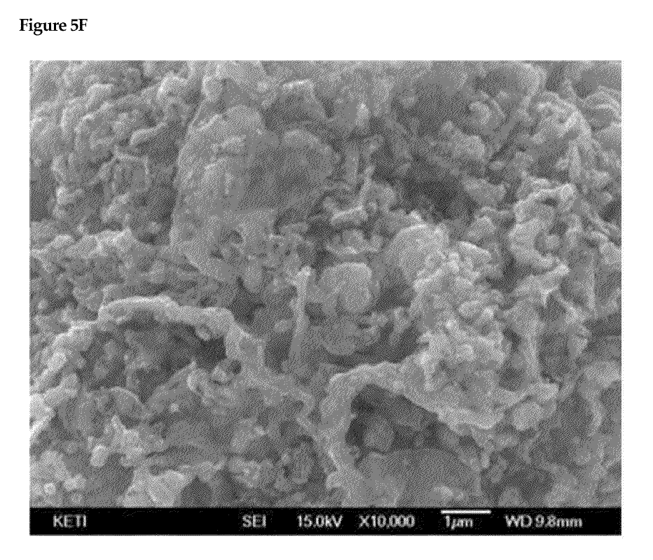

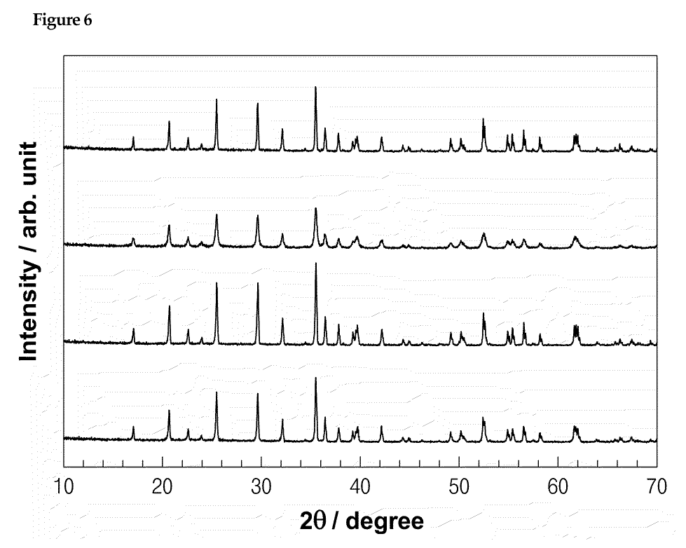

Equivalent amount of a lithium-based compound Li₃PO₄, a transition metal FeC₂O₄.2H₂O and phosphate-based compounds Li₃PO₄ and (NH₄)₂HPO₄ were dissolved in deionized water to provide a raw material mixture. 20 wt % of citric acid was added as a carbon source. The mixed solution was rapidly frozen in a freeze granulator (FIG. 3) and sublimated, followed by the removal of water at −5° C. and 10⁻³ Pa for 3 hours. The dried mixed solution was thermally treated under a 5% argon atmosphere at 500° C. for 5 hours to synthesize LiFePO₄/C.

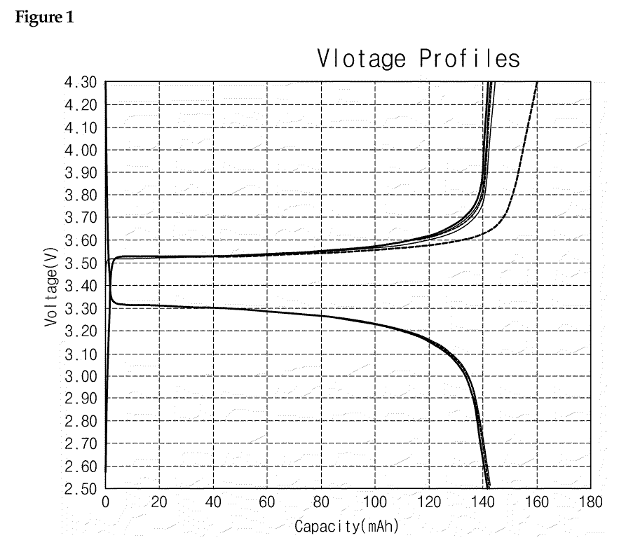

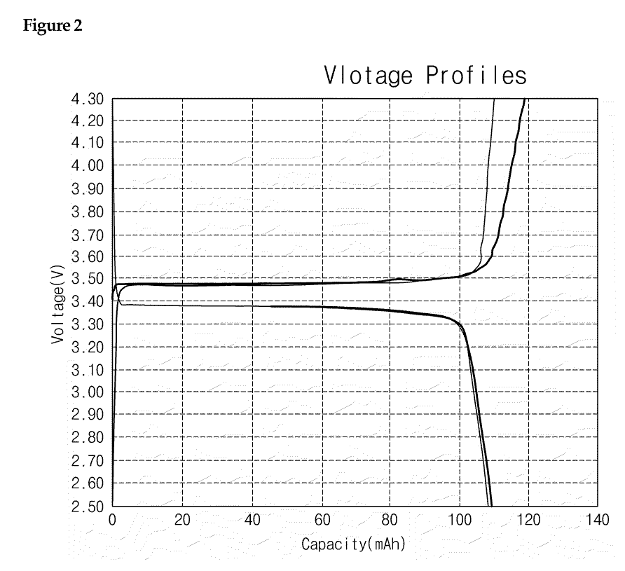

The heat capacity versus voltage of the LiFePO₄/C was shown in FIG. 1. LiFePO₄/C prepared herein shows a superior energy density (160 mAh/g), which amounts to one at least 30% improved compared to those of the conventionally prepared LiFePO₄/C (FIG. 2, 120 mAh/g).

A process of preparing a spherically-shaped positive active material for a lithium secondary battery of the present invention can overcome the problem of environmental pollution caused by the use of organic solvent in the mechanical pulverization and the sol-gel method. A process herein can also overcome the difficulty in preparing electrodes using nano-sized positive active material. The addition of carbon microparticles in the present invention enables the manufacture of active material with superior electric conductivity. Moreover, the raw material can be uniformly mixed in the present invention, thereby remarkably increasing the crystallinity. The spherical shape of particles is advantageous in the production of material useful for the preparation of electrodes.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A process of preparing a spherically-shaped positive active material for a lithium secondary battery, the process comprising:
(a) preparing a raw material mixture comprising a lithium-based compound, a transition metal, phosphate-based compound and a carbon source;
(b) preparing a mixed solution by uniformly dissolving the raw material mixture in deionized water;
(c) rapidly freezing the mixed solution in a freeze granulator;
(d) preparing a high density spherically-shaped precursor by sublimating the frozen mixed solution; and
(e) thermally treating the high density spherically-shaped precursor.

2. The process of claim 1, wherein the mixed solution comprises 8-12 wt % of the lithium-based compound, 40-50 wt % of the transition metal, 20-25 wt % of the phosphate-based compound and 0.1-30 wt % of the carbon source.

3. The process of daim 2, wherein the lithium-based compound is selected from the group consisting of LiPO₄, Li₂CO₃, LiOH and acetate-lithium; the transition metal is an iron-containing compound selected from the group consisting of FeSO₄.7H₂O, FeC₂O₄.2H₂O, iron oxalate and iron acetate; the phosphate-based compound is selected from the group consisting of phosphoric acid, ammonium phosphate and (NH₄)₂HPO₄; and the carbon source is citric acid.

4. The process of claim 1, wherein the molar ratio of the lithium-based compound and the transition metal is 0.95-1.10:1.

5. The process of claim 2, wherein the thermal treatment is conducted in a mixed gas comprising 3-7% of hydrogen and 93-97% of argon at 500-800° C. for 1-10 hours.

6. The process of daim 2, wherein the positive active material has a partide size of 5-20 μm.

7. The process of claim 1, wherein the positive active material is LiFePO₄/C.

8. The process of claim 7, wherein the LiFePO₄/C has a lithium/iron molar ratio of 0.98-1.02:1, and a phosphorus/iron molar ratio of 0.98-1.02:1.

9. A spherically-shaped positive electrode for a lithium secondary battery prepared according to a process comprising:
(a) preparing 35-42% of a solid matter by dissolving in N-methyl pyrrolidone (NMP) a mixture comprising (i) 85-90 wt % of the spherically-shaped positive active material prepared according to claim 1, (ii) 1-10 wt % of a conductive material and (iii) 1-10 wt % of a binder;
(b) coating the solid matter on an aluminum-foil;
(c) drying the coated solid matter at 110-120° C.; and
(d) roll-pressing the dried solid matter at 2 g/cc.

10. The spherically-shaped positive electrode for a lithium secondary battery of claim 9, wherein the conductive material is super-P+ carbon nanotube (vapor growth carbon fiber) and the binder is polyvinylidene fluoride (PVDF).
